(19) United States
(12) Patent Application Publication
(10) Pub. No.: US 2008/0027826 A1
(43) Pub. Date: Jan. 31, 2008

(54) METHOD, SYSTEM AND COMPUTER PROGRAM PRODUCT FOR FACILITATING THE TELECOMMUNICATION EQUIPMENT ORDERING PROCESS

(75) Inventors: Michael L. Popick, Marietta, GA (US); Marcee Burns, Marietta, GA (US); Danny R. Ashley, Marietta, GA (US); David W. Clark, Marietta, GA (US)

Correspondence Address: CANTOR COLBURN LLP - BELLSOUTH, 55 GRIFFIN ROAD SOUTH, BLOOMFIELD, CT, 06002, US

(73) Assignee: AT&T BLS Intellectual Property, Inc., Wilmington, DE (US)

(21) Appl. No.: 11/870,699

(22) Filed: Oct. 11, 2007

Related U.S. Application Data
(62) Division of application No. 10/648,751, filed on Aug. 25, 2003.

(51) Int. Cl. G06Q 30/00

(52) U.S. Cl. 705/26

(57) ABSTRACT

A method for facilitating the telecommunication equipment ordering process including creating a telecommunication equipment order record. The telecommunication equipment order record includes a telecommunication equipment order number, a project number, equipment data, accounting data, schedule data, supplier data and shipping data. The creating includes populating the order record in response to input from a creator. The accounting data is transmitted to an accounting system for verification of the accounting data. A verification status is received from the accounting system. The verification status is positive if the accounting data is located in the accounting system and the verification status is negative if the accounting data is not located in the accounting system. The order record is released into an order database accessible by users in response to the verification status being positive and to a request from the creator. The order record is updated by the creator in response to the verification status being negative and resubmitted to the accounting system.

### CROSS REFERENCE TO RELATED APPLICATION

This application is a divisional application of U.S. Ser. No. 10/648,751, filed Aug. 25, 2003, the contents of which are incorporated by reference herein in their entirety.

### FIELD OF THE INVENTION

The present disclosure relates generally to facilitating the telecommunication equipment ordering process and in particular, to a method of standardizing telecommunication equipment ordering across multiple geographic locations and business departments.

### BACKGROUND OF THE INVENTION

The ability to standardize on particular telecommunication equipment may result in cost savings to a corporation. These cost savings may be due to price discounts from suppliers based on higher volumes purchased and lower administration costs. In addition, costs savings may be due to ease of maintenance because standard products consist of similar components that will become familiar to the technicians and therefore may require less time to troubleshoot and repair. However, in a typical corporation, orders for telecommunication equipment (including hardware, software and services) are placed by each business department using different tools and processes. Requests for new equipment may be generated by copying an old order and then editing the document to reflect a new order request or by using a custom form created using off-the-shelf software. The copied data may no longer be valid and may lead to errors and delays in the ordering process. Shipping locations, account codes, material identifiers and component identifiers may be located in several different databases. These databases may contain multiple copies of the same data. In addition, the data in these databases may be maintained by multiple departments and multiple users, thereby causing inconsistent and out of date data to be stored in the databases. Each department or area may have its own databases that are not accessible by employees outside of the department. The use of multiple, fragmented databases maintained by individual departments may make it difficult to standardize on particular telecommunication services and products. In addition, each application created to support the ordering process and the corresponding database may be tailored to the particular department that owns the application and the database. Therefore, each application and database may perform the ordering process in a slightly different manner and this may make it difficult to standardize on particular configurations.

### BRIEF DESCRIPTION OF THE INVENTION

Embodiments of the present invention include a method for facilitating the telecommunication equipment ordering process. The method includes creating a telecommunication equipment order record including a telecommunication equipment order number, a project number, equipment data, accounting data, schedule data, supplier data and shipping data. The creating includes populating the order record in response to input from a creator. The accounting data is transmitted to an accounting system for verification of the accounting data. A verification status is received from the accounting system. The verification status is positive if the accounting data is located in the accounting system and the verification status is negative if the accounting data is not located in the accounting system. The order record is released into an order database accessible by users in response to the verification status being positive and to a request from the creator. The order record is updated by the creator in response to the verification status being negative and resubmitted to the accounting system.

Other embodiments of the present invention include a system for facilitating the telecommunication equipment ordering process including a network and a storage device in communication with the network. The storage device includes an order database. The system further includes a user system in communication with the network and a host system in communication with the network. The host system includes application software to implement a method. The method includes creating a telecommunication equipment order record including a telecommunication equipment order number, a project number, equipment data, accounting data, schedule data, supplier data and shipping data. The creating includes populating the order record in response to input from a creator. The accounting data is transmitted via the network to an accounting system for verification of the accounting data. A verification status is received from the accounting system via the network. The verification status is positive if the accounting data is located in the accounting system and the verification status is negative if the accounting data is not located in the accounting system. The order record is released into the order database accessible by users in response to the verification status being positive and to a request from the creator. The order record is updated by the creator in response to the verification status being negative and resubmitted to the accounting system.

Further embodiments of the present invention include a computer program product for facilitating the telecommunication equipment ordering process including a storage medium readable by a processing circuit and storing instructions for execution by the processing circuit for facilitating a method including creating a telecommunication equipment order record including a telecommunication equipment order number, a project number, equipment data, accounting data, schedule data, supplier data and shipping data. The creating includes populating the order record in response to input from a creator. The accounting data is transmitted to an accounting system for verification of the accounting data. A verification status is received from the accounting system. The verification status is positive if the accounting data is located in the accounting system and the verification status is negative if the accounting data is not located in the accounting system. The order record is released into an order database accessible by users in response to the verification status being positive and to a request from the creator. The order record is updated by the creator in response to the verification status being negative and resubmitted to the accounting system.

Other systems, methods and/or computer program products according to embodiments will be or become apparent to one with skill in the art upon review of the following drawings and detailed description. It is intended that all such additional systems, methods, and/or computer program products be within the scope of the present invention, and be protected by the accompanying claims.

### BRIEF DESCRIPTION OF THE DRAWINGS

Referring to the exemplary drawings wherein like elements are numbered alike in the several FIGURES:

FIG. 1 is a block diagram of an exemplary system for facilitating the telecommunication equipment ordering process;

FIG. 2 is flow diagram of an exemplary process for facilitating the telecommunication equipment ordering process;

FIG. 3 is an exemplary project record located in the order database;

FIG. 4 is an exemplary telecommunication equipment order record located in the order database;

FIG. 5 is an exemplary detail record located in the order database;

FIG. 6 is an exemplary user interface for accessing project information; and

FIG. 7 is an exemplary user interface for accessing telecommunication equipment order information.

### DETAILED DESCRIPTION OF THE INVENTION

Exemplary embodiments of the present invention include a method for facilitating the telecommunication equipment (including hardware, software and services) ordering process. The method may be utilized by capacity management organizations within a telephone company to order telecommunication equipment for central offices, controlled environment vaults (CEVs), HUTs (i.e., small, free standing structures), remote termination (RT) sites and customer premise locations. In addition, exemplary embodiments of the present invention may be utilized by agencies contracted by the telephone company to perform work activities that have been outsourced. Further, other organizations within the telephone company may utilize the look-up and search capabilities of exemplary embodiments of the present invention for analyzing current and future job projects occurring in a given location. Equipment ordering and provisioning may be standardized across departments within the telephone company using exemplary embodiments of the present invention. Exemplary embodiments of the present invention interact and gather data from existing applications to support the ordering of equipment and services. The equipment orders may identify the services for engineering, installation, minor material items, major material items and costs. Once completed, the equipment orders are made available to purchasing agents.

Exemplary embodiments of the present invention include an interactive interface between an accounting system and the order processing application to verify that the budgetary data and associated fields created by the order processing application for an order are in an acceptable format and within expected data ranges for the accounting system. In addition, accounting codes that are utilized by the order processing application (e.g., Supplier Code, Work Identification and Asset Category (WAP) code) may be added and updated in the accounting system master databases by an authorized order processing application user. Data that must be in a specific format or contain particular values (e.g., WAP codes, Geographic Location Codes (GLCs), Common Language Location Identifier (CLLI) categories) is verified before being accepted by the order database. In addition, specific detail records associated with an existing telecommunication equipment order (TEO) may be copied into another TEO. Further, authorized users of the ordering processing system may assign an authorization number to a project to indicate that expenditures have been approved.

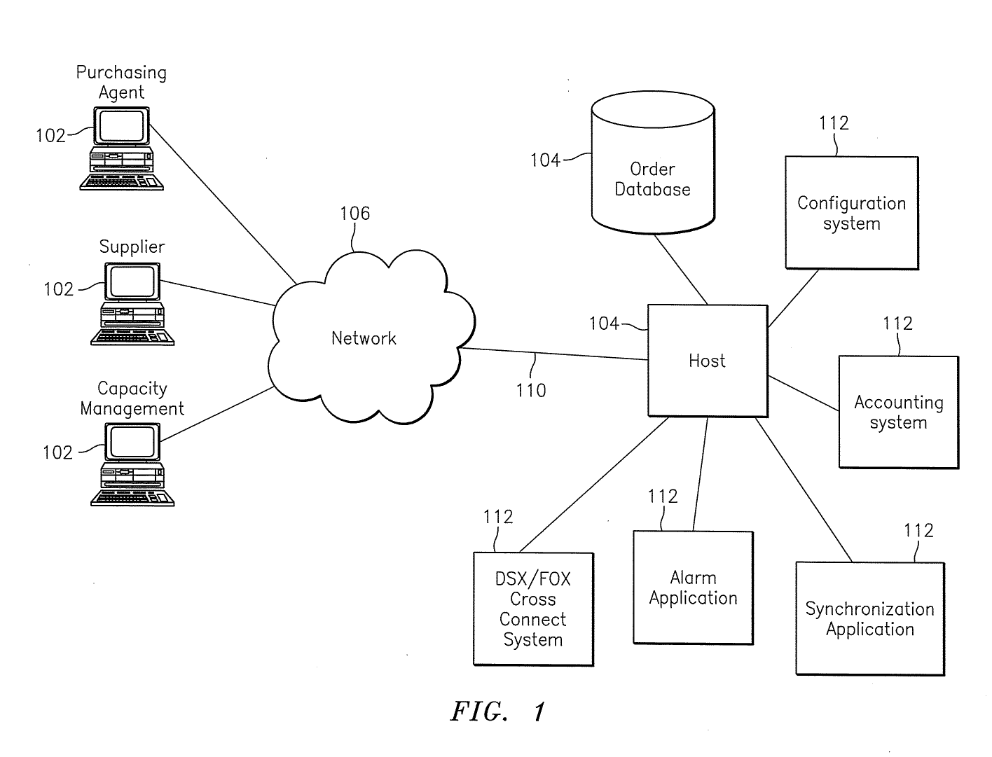

In FIG. 1, a block diagram of an exemplary system for facilitating telecommunication equipment ordering is generally shown. The exemplary system includes a host system 104 for executing an order processing application. The system in FIG. 1 also includes one or more user systems 102 through which users such as equipment suppliers, service suppliers, purchasing agents and corporate capacity management organization representatives located at one or more geographic locations may contact the host system 104 to initiate the execution of the order processing application. In exemplary embodiments of the present invention, the host system 104 executes the order processing application and the user system 102 is coupled to the host system 104 via a network 106. Each user system 102 may be implemented using a general-purpose computer executing a computer program for carrying out the processes described herein. The user system 102 may be a personal computer (e.g., a lap top, a personal digital assistant) or a host attached terminal. If the user system 102 is a personal computer, the processing described herein may be shared by a user system 102 and the host system 104 (e.g., by providing an applet to the user system 102).

The network 106 may be any type of known network including, but not limited to, a wide area network (WAN), a local area network (LAN), a global network (e.g. Internet), a virtual private network (VPN), and an intranet. The network 106 may be implemented using a wireless network or any kind of physical network implementation known in the art. A user system 102 may be coupled to the host system through multiple networks (e.g., intranet and LAN) so that not all user systems 102 are coupled to the host system 104 through the same network. One or more of the user systems 102 and the host system 104 may be connected to the network 106 in a wireless fashion. In exemplary embodiments of the present invention, the user system 102 is connected to the host system 104 via a network such as a private LAN and the host system 104 executes the order processing application software.

The storage device 108 depicted in FIG. 1 may be implemented using a variety of devices for storing electronic information. It is understood that the storage device 108 may be implemented using memory contained in the host system 104 or it may be a separate physical device. The storage device 108 is logically addressable as a consolidated data source across a distributed environment that includes a network 106. The physical data may be located in a variety of geographic locations depending on application and access requirements. Information stored in the storage device 108 may be retrieved and manipulated via the host system 104. The storage device 108 includes an order database. In exemplary embodiments of the present invention, the order database is relational and includes project records, TEO records and detail records. The storage device 108 may also include other kinds of data such as information concerning the creation of the order database records (e.g., date and time of creation). In exemplary embodiments of the present invention, the host system 104 operates as a database server and coordinates access to application data including data stored on storage device 108. Access to data contained in the order database may be restricted based on user characteristics. For example, a service supplier user may not have access to any financial data while a telephone company employee user in the capacity management organization may have access to view financial data relating to an order but not to update the financial data. Any number of data access combinations are possible and may be implemented based on implementation requirements.

The host system 104 depicted in FIG. 1 may be implemented using one or more servers operating in response to a computer program stored in a storage medium accessible by the server. The host system 104 may operate as a network server (e.g., a web server) to communicate with the user system 102. The host system 104 handles sending and receiving information to and from the user system 102 and can perform associated tasks. The host system 104 may reside behind a firewall to prevent unauthorized access to the host system 104 and enforce any limitations on authorized access. A firewall may be implemented using conventional hardware and/or software as is known in the art.

The host system 104 may also operate as an application server. The host system 104 executes one or more computer programs to facilitate the telecommunication equipment ordering process. One or more application programs within the host system 104 share information to support the ordering process. The network 110 has the same characteristics described previously for network 106. In exemplary embodiments of the present invention, network 110 is a private LAN network. In alternate embodiments, the network 110 is the same physical network as network 106.

As depicted in FIG. 1, in exemplary embodiments of the present invention, the existing application systems 112 may include: a cross-connect system for identifying where fiber optic and copper cables terminate as well as identifying spare capacities; an alarm telemetry application for identifying alarm and monitoring requirements; a synchronization database application for administration of timing and synchronization assignments; an accounting system for tracking expenditures and account codes related to the order; and a configuration system for determining the right combination of equipment and services to be ordered. Data and processing may be shared in a real time/interactive mode or they may be shared in a batch mode depending on application requirements and the capabilities of the existing application systems 112. Each application system 112 may be executed by one or more computer systems 102 and may be located geographically remote from other application systems 112 and from the host system 104.

The processing of the ordering processing application may be shared by a user system 102 and the host system 104 by providing an application (e.g., java applet) to the user system 102. As previously described, it is understood that separate servers may be utilized to implement the network server functions and the application server functions. Alternatively, the network server, the firewall, and the application server may be implemented by a single server executing computer programs to perform the requisite functions.

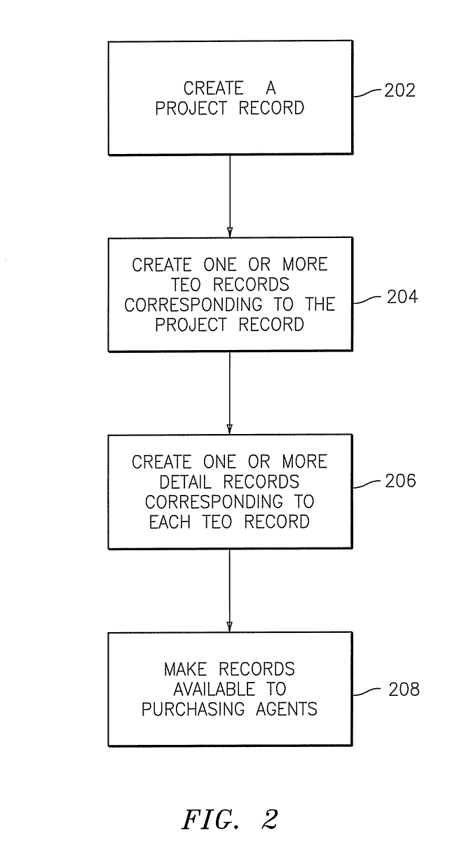

FIG. 2 is flow diagram of an exemplary process for facilitating the telecommunication equipment ordering process. At step 202, a project record is created by a user, located at a user system 102 accessing the order processing application located on the host system 104. The project record is stored in the order database located on the storage system 108. Each project record may correspond to one or more telecommunication equipment order (TEO) records and each TEO record may correspond to one or more detail records. Equipment orders may include hardware, software and/or services orders.

The project record may be created, at step 202, by copying an existing project record (and the associated TEO and detail records) and then editing it; by copying a template project record (and the associated TEO and detail records) and then editing it; or by entering all required fields into a blank project record. When the user creates a new project record by copying from an existing project record or from a template project record, a validation check is performed against a listing of valid Work Identification and Asset Category (WAP) codes in an accounting application system 112, or in a database associated with the accounting application system 112, to verify that the WAP code is still valid. If the WAP code is not valid, the order processing application does not copy the invalid WAP code into the new project record and alerts the user to the invalid WAP code. Performing this validation check may result in fewer projects being rejected by the accounting application system 112 due to invalid WAP codes. Similarly, a validation check is performed against other accounting data fields, such as Geographic Location Code (GLC) and Common Language Location Identifier (CLLI) codes, in the accounting application system 112 to verify that the GLC and CLLI codes are still valid. If they are not valid, the order processing application does not allow the invalid GLC and/or CLLI code to be copied into the new project record. Access to the accounting data may be via the accounting application system 112, or alternatively, the order processing application may have direct read access into a database associated with the accounting application system 112. Other fields in the accounting application system 112 or in other application systems 112 may also be verified in a similar manner. The verification may result in a positive verification status if the order processing data is found to be valid and a negative verification status if the data is found to be invalid.

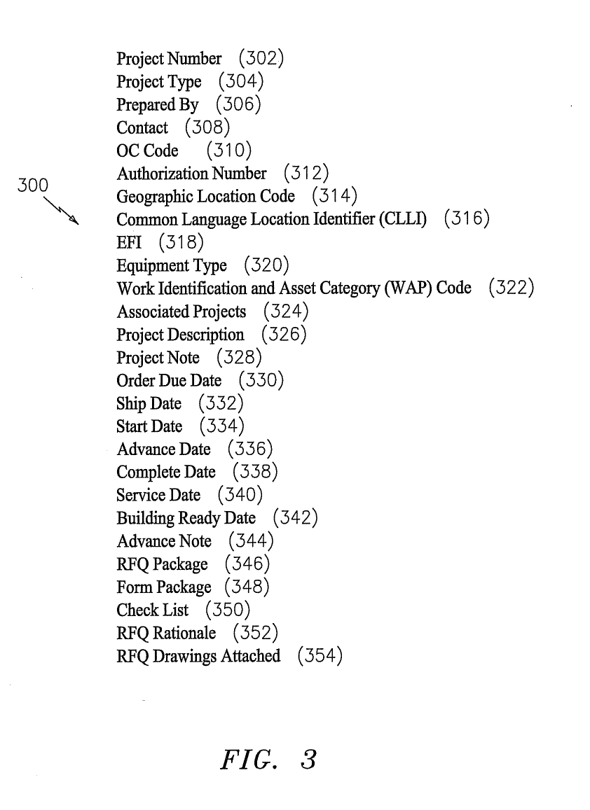

An exemplary order database project record 300 is depicted in FIG. 3. The Project Number field 302 is a unique number assigned to the project and may be utilized as a key into the project record 300. If the project number entered into the Project Number 302 field by the user matches a project number in the accounting system, the user may download project related information into the project record 300 from the accounting system. The Project Type field 304 identifies the account classification used to track expenditure to specific budgets. The Prepared By field 306 stores the initials of the engineer preparing the project and it defaults to the initials of the user. Contact field 308 refers to the initials of the ordering company's contact person. The OCC Code field 310 identifies the department/organization whose budget is being impacted by this project expenditure. Authorization Number field 312 refers to a code that signifies that the project expenditures have been approved by appropriate management. Approved users may enter a code into the Authorization Number field 312 to signify that the project expenditures have been approved. The GLC field 314 identifies the building location where the investment is being installed, the investment location is identified at a higher level of location by the CLLI location within the building. Each GLC field 314 may be assigned multiple CLLI codes that are stored in the CLLI field 316. Assigning multiple CLLIs to one GLC allows technology deployments to be tracked in lieu of being lumped together allowing investments of the same type to be tracked to different units of the business. The CLLI field 316 may be verified against the accounting application system 112 as described previously. The Engineer, Furnish and Install (EFI) field 318 contains instructions that are entered by the user. In exemplary embodiments of the present invention any combination of E (engineer), F (furnish) and I (install) are possible (e.g., E, F, I, EF, EI, FI and EFI) values of the EFI field 318. The Equipment Type field 320 refers to the specific function of the type of equipment being installed (e.g., ADSL for high digital access, 5ESS for a specific type of switching equipment.

An exemplary project record 300 also includes a WAP Code field 322. As described previously, the data in the WAP Code field 322 is validated against data in the accounting application system 112 before being added to the project record 300. The WAP Code field 322 is utilized to track the cost of the project for accounting and budgeting purposes. A new WAP code may be added to the accounting system data base of WAP codes as long as the user has the proper authority. The Associated Projects field 324 contains the project numbers of any other projects associated with the project being described in the project record 300. Project Description field 326 and Project Note field 328 allow the user to enter text data relating to the project. In addition, several dates are tracked in the project record 300 via the following fields: Order Due Date field 330; Ship Date field 332; Start Date field 334; Advance Date field 336, specifies to the installation vendor that a defined portion of the telephone equipment order needs to be completed; Complete Date field 338, contains the actual completion date; Service Date field 340, contains the date that the equipment is targeted to go into service; and Building Ready Date field 342, holds the date that the building must be ready for the equipment. These dates are utilized for project tracking and monitoring purposes.

The Advance Note field 344 in the project record 300 includes text data entered by the user that relates to the Advance Date field 336, if an Advance Date field 336 has been input then this field must contain explanatory text data. The Request for Quotation (RFQ) Package field 346 and Form Package field 348 may be left blank or alternatively, they may contain a package selected from a list of corresponding package numbers. Similarly, the Check List field 350 may be left blank or it may be selected from a list of checklists presented to the user. The RFQ Rationale field 352 contains rationale for selecting the vendor for the project if the vendor selected is not the standard vendor. RFQ Drawings Attached field 354 holds the value “Yes” if they are electronically attached to the project record 300 and the value “No” if they are not electronically attached to the project record 300. Once all the data has been entered into the project record 300, the user selects an execute option and the project record 300 is added to the order database located on the storage device 108.

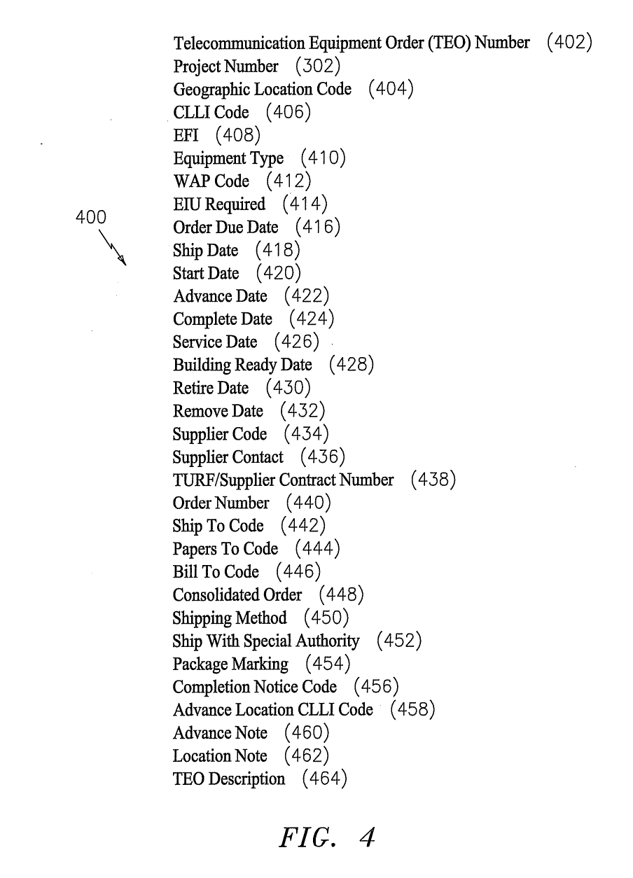

Referring back to FIG. 2, at step 204, one or more TEO records corresponding to the project record 300 are created by the user. Similar to the project record 300, the TEO records 400 may be created by copying from a template, copying from an existing TEO record or by entering the TEO data into a blank TEO record 400 as depicted in FIG. 4. If a TEO record 400 is copied from a template TEO or from an existing TEO record, the user may select the sub-orders that they are interested in and only that subset of the order will be copied into the new TEO record 400 as a starting value that may be updated by the user. In addition, information from the corresponding project record 300 may be added into the TEO record 400 as a starting value. A Telecommunication Equipment Order (TEO) Number field 402 is assigned to the TEO so that the combination of Project Number field 302 and TEO Number field 402 is unique within the order processing system. Similar to the process described above in reference to a project record 300, the user may enter or update the accounting data including: the Geographic Location Code field 404, the CLLI Code field 406, the EFI field 408, the Equipment Type field 410, the WAP Code field 412. These accounting data elements may be verified against an existing accounting application system 112 in the manner previously described. The user also enters data into an Ethernet Interface Unit (EIU) Required field 414, the value is “yes” if an EIU is required and “no” if an EIU is not required. In addition, the user enters data into or edits the following schedule or date fields: Order Due Data field 416; Ship Date field 418; Start Date field 420; Advance Date field 422; Complete Date field 424; Service Date field 426; Building Ready Date field 428; Retire Date field 430, refers to the date when an investment (equipment) is removed from providing service; and Remove Date field 432, refers to the date when an investment (equipment) is removed from the building.

The TEO record 400 also includes several supplier related data fields. A Supplier Code field 434 may be typed in by the user or selected from a drop-down menu. The user may enter a new supplier code field 434 to the list of standard supplier codes if the user does not see a particular supplier code and the user has proper authority. Similarly, the Supplier Contact field 436 and TURF (defined as a specific geographical are assigned to an installation vendor)/Supplier Contract Number field 438 may be entered by the user or selected from a drop-down menu. Other supplier related fields in the TEO record include: Order Number field 440; Ship To Code field 442, code for the ship contact; Papers To Code field 444, code for the papers contact; and Bill To code field 446, code for the billing contact. Shipping related fields are also included in the TEO record 400. In exemplary embodiments of the present invention, shipping fields include: Consolidated Order field 448, “yes” if order should be consolidated and “no” otherwise; Shipping Method field 450, defaults to “Best Way” but may be overtyped; Ship With Special Authority field 452; and Package Marking field 454, defaults to the TEO Number field 402 but may be overtyped. The TEO record 400 depicted in FIG. 4 also includes: Completion Notice Code field 456; Advance Location CLLI Code field 458; Advance Note field 460; Location Note field 462 and TEO Description field 464.

At step 204 in FIG. 2, once all the TEO record 400 data has been entered, the user selects an execute option and the TEO record 300 is validated and then added to the TEOPS database located on the storage device 108. Validation performs a check to be sure that the data in the TEO record 400 is consistent with the data in the existing application systems 112. For example, TEO record, including the accounting data elements and associated fields in the TEO record 400, along with the associated project record 300 are sent to the accounting system application system 112. The order database records are checked against data in the accounting application system 112. If there are any discrepancies, the order database records are rejected and the user is prompted to correct the data fields that are in error. The user then resubmits the order database records to the accounting application system 112 in an on-line manner. In addition, a user of the order processing application may view the status of order database records in the accounting application system 112 and receive rejection notices and information in an on-line, real-time manner. If the user sees that a project is missing from the accounting application system 112, the user may resubmit the project and associated order database records to the accounting system.

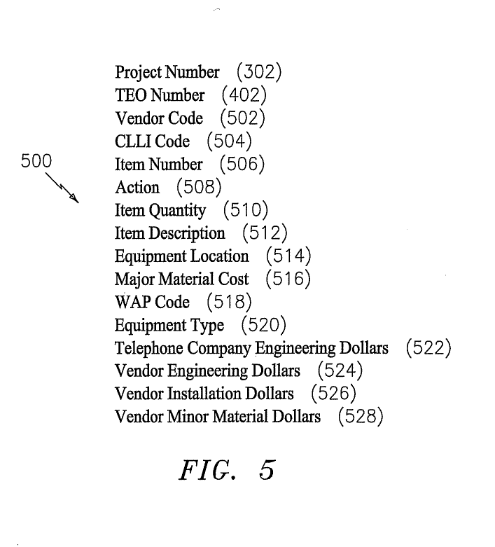

At step 206, in FIG. 2, the user may create one or more detail records, or sub-orders, corresponding to each TEO record 400. The user may copy from an existing detail record or create a new detail record. FIG. 5 depicts exemplary embodiments of an order processing database detail record 500 that contains an item that is neither driver nor component related. This normally occurs in the case where equipment is being trailed and there is no data in any databases to pull specific equipment components/part numbers. The detail record 500 includes: a Project Number field 302; a TEO Number field 402; a Vendor Code field 502; a CLLI Code field 504, initialized with the value in the CLLI Code field 406 from the TEO record 400; and an Item Number field 506. The user may also enter: an Action field 508 (e.g., add, remove, provide); an Item Quantity field 510; an Item Description field 512; and an Equipment Location field 514. Accounting information is also added to the detail record 500. As depicted in FIG. 5, accounting information includes: Major Material Cost field 516; WAP Code field 518; Equipment Type field 520, either software or hardware; Telephone Company Engineering Dollars field 522; Vendor Engineering Dollars field 524; Vendor Installation Dollars field 526; and Vendor Minor Material Dollars field 528. Access to the information in the accounting fields is restricted based on user characteristics.

Additional fields may be added to the detail record 500 if it relates to an item that is driver and component related. The user may select one or more drivers from a list of available drivers. A driver is defined as a specific set of work functions required to install the equipment. In addition, an application system 112 that performs configuration management may be executed based on a required part number to verify the selected configuration and to make suggestions if it does not fit a standard configuration. In exemplary embodiments of the present invention, output from the configuration management application system 112 is fed directly into the order processing system. In addition, information from the alarm application system 112 may be fed directly into the order processing system to recommend suggested performance monitoring tools and alarms for the equipment. Interfaces to other application systems 112 may be utilized to verify data and/or to populate the order database records. The user has the option to select DSX, FOX or synchronization anytime before the order is sent to the vendor, when selected, the user can preview spare facilities and post reservations.

Order database records may be viewed, updated and deleted by users with proper authorization. Access may be limited to particular fields in a database record based on the type of user requesting the access. The same verifications described above may be performed when the user is attempting to change an order database record. Authorized users may create standard templates for projects and associated TEOs. These templates may be tailored to local, or regional, requirements or they may be applicable to all order processing users. Regional templates may include further data such as a model number for the equipment, unit shelf location, an item note and an assigned status of the model. The record layouts described previously may vary based on specific implementation requirements and data that is available from the existing application systems 112.

Next, at step 208, in FIG. 2, the new order database records are made available to purchasing agents so that an order for the equipment may be placed. In addition, the order database records are available to suppliers via user systems 102 connected to the network 106. Prompts may be available for all fields described above. In some cases, the user is forced to select one of the prompts and in others the user may use the prompts for assistance and enter other values in the data field. All date fields include prompts to assist the user in selecting dates. In addition, reports may be created based on the data contained in the order database records. For example, a report including the pricing by project (including hauling costs) and within each project by TEO may be generated, or, a report including all projects within two weeks of the completion date may be generated. In exemplary embodiments of the present invention, the order database is a relational database and any fields in the database may be queried to tailor a report to user requirements or the data may be made available for ad-hoc reporting by authorized users.

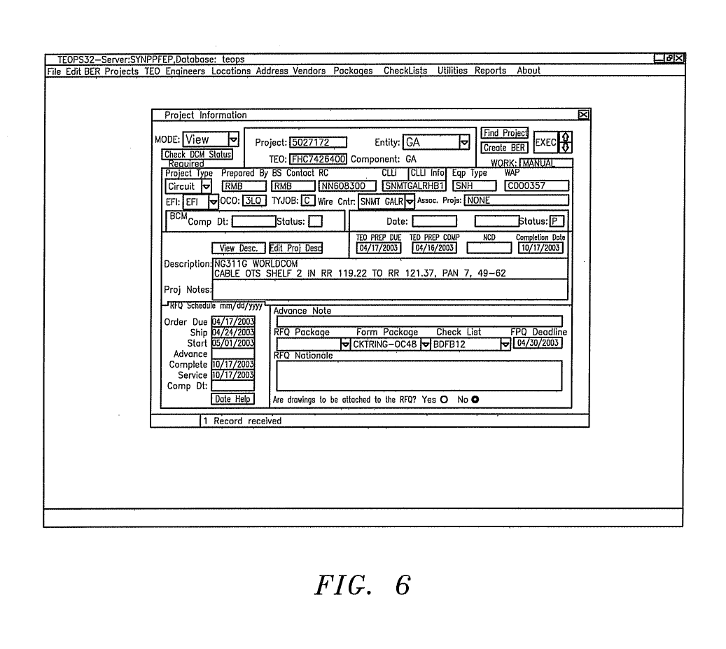

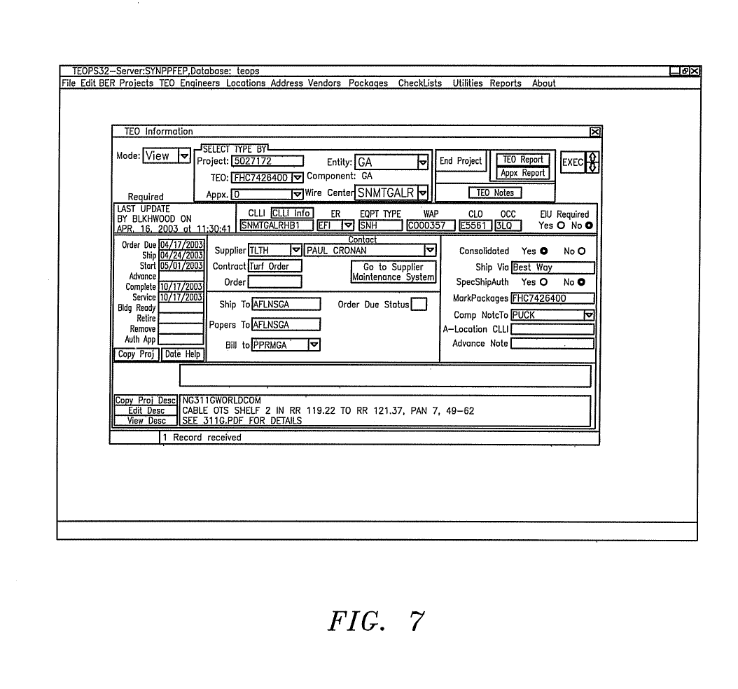

FIG. 6 is an exemplary user interface for viewing, deleting, updating and adding project information into a project record 300. The project information user interface 600 depicted in FIG. 6 includes the fields described above in reference to the project record 300. FIG. 7 is an exemplary user interface for viewing, deleting, updating and adding TEO information into a TEO record 400. The TEO information user interface 700 depicted in FIG. 7 includes the fields described above in reference to the TEO record 400.

Exemplary embodiments of the present invention facilitate telecommunication equipment ordering. Ease in creating and using standard equipment configurations may lead to reduced purchase and maintenance costs as well as consistent pricing across multiple departments in a company. Templates may be created for local use so that configurations may be modified to meet local requirements, if required. Embodiments of the present invention provide a host system 104 running an order processing application that is accessible via a network 106 such as the Internet. Having the order processing application network accessible allows purchasing agents, vendors and suppliers to be located in any geographic location. This may provide for more flexibility in selecting vendors and suppliers because they may be physically located anywhere. In addition, corporate capacity management organization administrators and technicians in the field may be located in any geographic location to create, view or update equipment orders. Electronic interfaces with existing application systems 112 for order related data may lead to removing redundant work steps and to more reliable configurations. Finally, the ability to have all orders in a central location may eliminate the need for e-mailing and faxing project order requests between purchasing agents and the suppliers and/or vendors filling the orders.

As described above, the embodiments of the invention may be embodied in the form of computer-implemented processes and apparatuses for practicing those processes. Embodiments of the invention may also be embodied in the form of computer program code containing instructions embodied in tangible media, such as floppy diskettes, CD-ROMs, hard drives, or any other computer-readable storage medium, wherein, when the computer program code is loaded into and executed by a computer, the computer becomes an apparatus for practicing the invention. An embodiment of the present invention can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer, the computer becomes an apparatus for practicing the invention. When implemented on a general-purpose microprocessor, the computer program code segments configure the microprocessor to create specific logic circuits.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims. Moreover, the use of the terms first, second, etc. do not denote any order or importance, but rather the terms first, second, etc. are used to distinguish one element from another.

What is claimed is:

1. A system for facilitating the telecommunication equipment ordering process, the system comprising:
a network;
a storage device in communication with said network, wherein said storage device includes an order database;
a user system in communication with said network; and
a host system in communication with said network, said host system including application software to implement a method comprising:
creating a telecommunication equipment order record including a telecommunication equipment order number, a project number, equipment data, accounting data, schedule data, supplier data and shipping data, wherein said creating includes populating said order record in response to input from a creator via said user system;
transmitting said accounting data via said network to an accounting system for verification of said accounting data;
receiving a verification status from said accounting system via said network, wherein said verification status is positive if said accounting data is located in said accounting system, and said verification status is negative if said accounting data is not located in said accounting system;
releasing said order record into said order database accessible by users in response to said verification status being positive and to a request from said creator;
updating said order record in response to said verification status being negative and to input from said creator; and
resubmitting said order record to said accounting system in response to said updating.

2. The system of claim 1 wherein said network is the Internet.

3. The system of claim 1 wherein said network in an intranet.

4. The system of claim 1 wherein said order database is a relational database.

5. A computer program product for facilitating the telecommunication equipment ordering process, the computer program product comprising:
a storage medium readable by a processing circuit and storing instructions for execution by the processing circuit for facilitating a method comprising:
creating a telecommunication equipment order record including a telecommunication equipment order number, a project number, equipment data, accounting data, schedule data, supplier data and shipping data, wherein said creating includes populating said order record in response to input from a creator;
transmitting said accounting data to an accounting system for verification of said accounting data;
receiving a verification status from said accounting system, wherein said verification status is positive if said accounting data is located in said accounting system, and said verification status is negative if said accounting data is not located in said accounting system;
releasing said order record into an order database accessible by users in response to said verification status being positive and to a request from said creator;
updating said order record in response to said verification status being negative and to input from said creator; and
resubmitting said order record to said accounting system in response to said updating.
